(19) United States
(12) Patent Application Publication
(10) Pub. No.: US 2014/0134577 A1
(43) Pub. Date: May 15, 2014

(54) Kid Garden Phonics

(71) Applicant: Jean Borne McCaulley, Nathrop, CO (US)

(72) Inventor: Jean Borne McCaulley, Nathrop, CO (US)

(21) Appl. No.: 13/674,794

(22) Filed: Nov. 12, 2012

(51) Int. Cl. G09B 17/00

(52) U.S. Cl. CPC G09B 17/00
USPC 434/178

(57) ABSTRACT

This reading program was created from a previous kinesthetic reading program created by the same author. In the previous reading program, large motor movements were added to the phonics process, which is to link the visual letter with the audio sound in the learner's mind. The large motor movements helped even three and four year olds remember their phonics sounds. This program taught all the sounds in order of frequency of use. It was copyrighted as Early Childhood Kinesthetic Learning: Kid Garden Curriculum 2008 (Registration Number TXu 1-616-272 Jan. 28, 2008).

The reading program has been changed sufficiently to need a patent on the new method. The additions of American Sign Language signs for the letters along with the original kinesthetic movements are in the new program for each letter-sound connection.

### DETAILED DESCRIPTION OF THE INVENTION

A printed manual and DVD movie will be available to teach parents and teachers how to present the materials.

Presentation: Each letter is presented in its own lesson, not more than one per day. The letter and sound are presented in both uppercase and lowercase, called the parent and child, respectively. Plastic, wood, or sandpaper versions of both cases of the letter are shown and then the movement and sound are presented. Pictures and objects that begin with the phoneme are shown and the movement and sound are practiced after each picture/object is presented.

Practice: The action is made while saying sound as a response to seeing the letter in the phonics process. This process can be reversed so the learner hears the sound, does the action and finds the letter. This is useful in writing and journaling, using invented spelling, and is detailed in Reverse Phonics, p. 6. It is called reverse phonics because it is the same skill as phonics, letter to sound, only reversed to be sound to letter, with the movement still linking the process in the brain. It becomes a superhighway in the brain so the student is able to remember quickly and easily.

***Age is a consideration. When teaching 3-5 year olds, the sounds with indented italics should be taught after all the sounds are taught. Teach the underlined sounds first.

### LETTER SOUND MOVEMENTS

### The Letter Prompts the Movement and The Sound

a ASL ‘A’ is made with both hands and is used in the following movements:

/a/ at (open and close alligator jaws made with straight arms, fingers in ASL ‘A’)

/A/ ate (arms straight up over head in “hooray!”, fingers in ASL ‘A’)
[/o/ ball (arms out to side waving like an octopus)]
[/u/ villa tap stomach with fist)]

b ASL ‘B’ is made with one hand
/b/ bear (tap lips with ASL ‘B’)

c ASL ‘C’ is made with one hand

/k/ cat (smooth your cat whiskers with an ASL ‘C’)
[/s/ city (move hand like a snake)]

d ASL ‘D’ is made with both hands
/d/ deer (make deer horns on head, thumbs/finger circle to head and fingers pointed up)

e ASL ‘E’ is made with both hands
/e/ end (arms straight down with hands together, swing elephant trunk side to side)

/E /me (point to ear)

f ASL ‘F’ is made with both hands

/f/ fish (put thumb/fingers together; wiggle fingers to make a fish)

g ASL ‘G’ is made with one hand

/g/ give (present hands with a gift)
[/j/ gym (hold arms in front, wiggle fingers jellyfish-like)]

h ASL ‘H’ is made with both hands

/h/ hot (fan self with fingers while breathing on other fingers)

i ASL ‘I’ is made with one hand

/i/ inch (baby finger moves like an inchworm)

/i/ ivy (point to eye)

j ASL ‘J’ is made with both hands

/j/ jelly (alternate sweeping baby fingers upward)

k ASL ‘K’ is made with both hands

/k/ kick (kick with one leg with hands in sign)

I ASL ‘L’ is made with one hand

/l/ lizard (pretend to lick a lollipop; the lollipop is the sign)

m ASL ‘M’ is made with one hand

/m/ mouse (rub tummy with sign)

n ASL ‘N’ is made with one hand

/n/ no (wag sign ‘no’)

o ASL ‘O’ is made with both hands

/o/ got (hands in sign; arms out to side waving like an octopus)

/O/ go (make O with hands at chest, push away)

/U/ to (put sign at bridge of nose)

p ASL ‘P’ is made with both hands

/p/ penguin (hands in sign; stiffen both arms like a penguin and waddle side to side)

q ASL ‘Q’ is made with one hand

/kw/ queen (make circle like a crown with hand on head, finger pointed down)

r ASL ‘R’ is made with both hands

/r/ rat (make rabbit paws at chest with sign)

s ASL ‘S’ is made with one hand

/s/ so (move hand like a snake)
[/z/ as (put fingers against cheek as if sleeping)]

t ASL ‘T’ is made with both hands

/t/ top (extend arms to the side, making body into a ‘T’)

u ASL ‘U’ is made with both hands

/u/ us (tap stomach with sign)

/U/ use (point to ‘you’ with sign)

/U/ fruit (touch sign to bridge of nose)

/oo/ push (push both hands away from chest)

v ASL ‘V’ is made with one hand

/v/ valentine (make V with two fingers and vibrate them)

w ASL ‘W’ is made with one hand

/w/ wave (wave hand side to side with three fingers)

x ASL ‘X’ is made with both hands

/x/ box (cross signs to make an X)

y ASL ‘Y’ is made with one hand

/y/ yam (make hand into phone by ear)
[/E/ baby (point to ear—at end of word only)]
[/l/ my (point to eye—at end of words)]

z ASL ‘Z’ movement is made with one hand

/z/ zap (make sign movement then put fingers against cheek as if sleeping)

### Blending the Sounds by Patting the Sounds

SKILL: The student will put the sounds together to read a word.
ACTIVITY: When presented with the word cat, the teacher models patting each sound on her arm and inviting the student to join her. She starts by patting her hand and says /c/. She then pats her mid-arm and says /a/. She then pats her shoulder and says /t/. She sweeps her arm from hand to shoulder and says ‘cat’, putting all the sounds together.

### Reverse Phonics

SKILL: The student hears a sound and responds with the appropriate letter, using the movement to remember.
MATERIALS: Journal with blank pages.

### ACTIVITY:

1) The student draws a picture in the journal. The student names the picture.

2) The teacher helps the student hear the sounds in the word that names the picture, patting the sounds.

3) The teacher asks the student to find the letter that makes the first sound of the picture name.

4) The student finds the letter and moves it to the mat or points to it on a familiar ABC chart.

5) The teacher shows the student where to write the letter, with help as needed.

6) The same procedure follows for each subsequent sound.

7) When all the sounds are written, the student reads it.

### Following Digraphs, Trigraphs, Diphthongs, and Blends are Presented After the Student is Adept at Writing and Blending Sounds

### DIGRAPHS: Two Letters Make One Sound (No ASL Sign Language)

ch /ch/ child (put bent arms at sides, move like train)

ph /f/ phone (put one hand on the back of the other; wiggle thumbs)

sh /sh/ she (fingers to lips)

th /th/ think (unvoiced, show thumb)

wh /wh/ wheel (wave hand with three fingers)

ck /k/ duck (kick with one leg with hands in fist)

tch /ch/ catch (put bent arms at sides, move like train)

nk /nk/ ink (scrunch nose, put fingers in mouth corners, kick foot)

dge /j/ dodge (hold arms in front, wiggle fingers jellyfish-like)

### —ING Brothers

ng /ng/ sing (scrunch nose, put fingers in mouth corners)

### —ED Sisters:

ed /ed/ faded (tap chest)
/d/ pulled (make deer horns on head, thumbs to head and index fingers pointed)
/t/ pushed (extend arms to the side, making body into a ‘T’)
   TRIGRAPHS: three letters make two sounds:

chr /k//r/ chrome (kick then rabbit paws at chest)

### DIPHTHONGS: Two Adjacent Vowels and Vowel Sounds Occurring Within the Same Syllable (No ASL Sign Language)

ai, ay, ey, eigh paint, day, they, eight /A/ (arms straight up over head in “hooray!”)

ee, ea, ey tree, sea, key /E/ (point to ear)

ie, eye, igh pie, eye, sigh /l/ (point to eye)

ow, oa, oe, ough snow, boat, toe, dough /O/ (make O, hands at chest, push away)

ue, ew, oo due, new, boo /U/ (pinch top of nose) or (point to ‘you’ with sign)

oo, book (push both hands away from chest)

ow, ou how, house (pinch back of hand as if it hurts)

oy, oi boy, soil (hit forehead with palm of hand)

aw, au law, fault (arms out to side waving like an octopus)

Naughty or Silent E at end of word: (tape) makes long sound of vowel, as above.

### BOSSY “R”: “R” Controls and Changes the Vowels (Some ASL Sign Language)

er, ir, ur /r/ her, first, nurse (make rabbit paws at chest with sign)

ar /ar/ park (pirate sound: /ar/ wink and move fist)

or /or/ or (shrug shoulders)

### MR. GH:

At the end of the word, Mr. GH either says no sound at all or /f/ dough, laugh

At the beginning of the word, Mr. GH says /g/ ghost

### BLENDS: Two or Three Distinct Consonant Sounds: (ASL and Movement is Made For Each Sound In Turn)

List of blends:

| | | | | | | | | | | | | |
|---|---|---|---|---|---|---|---|---|---|---|---|---|
| bl | cl | fl | gl | pl | sl | br | cr | dr | fr | gr | pr | tr |
| sm | sn | sp | st | sw | sc | sk | thr | scr | squ | spl | str | spr |
| nd | | | | | | | | | | | | |

The embodiments of the invention in which an exclusive property or privilege is claimed are defined as follows:

1) Reading is taught through unique movements that associate sounds/phonemes with their letters.

2) The American Sign Language letter is made with the hands/fine motor while the movement is made with the large motor.

3) Letters are taught in alphabetical order.

4) All movements for the sounds of the letter are taught order of most frequent use. For example, letter Aa has four sounds taught in frequency of use: /a/ (apple), /A/ (apron), /o/ (ball), /u/ (villa). A different movement is made for each with the hands still in the ASL sign for Aa. Some letter sounds are taught after all basic sounds are taught. (see ***Age is a consideration, p. 1, Detailed Description)

5) Digraphs, trigraphs, diphthongs, and blends have movements unique to this reading method (p 5-6, Detailed Description).

6) The technique used in Reverse Phonics (p. 5, Detailed Description) is exclusive to this reading method because it uses the sound to produce the unique movement in order to remember, produce, and write the sound during the writing process, specifically journaling.
